(19) United States
(12) Patent Application Publication
(10) Pub. No.: US 2016/0023370 A1
(43) Pub. Date: Jan. 28, 2016

(54) UNREELING DEVICE FOR AN INTERLEAVER REEL, AND SYSTEM CONSISTING OF A SLITTING DEVICE AND THE UNREELING DEVICE

(71) Applicant: GEA Food Solutions Germany GmbH, Biedenkopf-Wallau (DE)

(72) Inventor: Ralf-Peter Müller, Kempten (DE)

(73) Assignee: GEA Food Solutions Germany GmbH, Biedenkopf-Wallau (DE)

(21) Appl. No.: 14/773,854

(22) PCT Filed: Mar. 20, 2014
(86) PCT No.: PCT/EP2014/055600

§ 371 Date: Sep. 9, 2015

(30) Foreign Application Priority Data
Mar. 20, 2013 (DE) 10 2013 204 956.0

(51) Int. Cl. B26D 7/32; B65H 35/06; B65H 26/00; B65H 16/02; B65H 23/04

(52) U.S. Cl. CPC B26D 7/325; B65H 16/023; B65H 23/04; B65H 26/00; B65H 35/06

(57) ABSTRACT

The present invention relates to an unreeling device, by way of which an interleaver strip is unreeled from an interleaver reel. Furthermore, the present invention relates to a system consisting of a slitting device and the unreeling device.

The present invention relates to an unreeling device with which an interleaver strip is unreeled from an interleaver reel. Furthermore, the present invention relates to a system comprising a cutting device and the unreeling device.

Interleavers, for example pieces of paper, are placed between two slices or food, for example, in order to reduce the adhesion thereof to one another, and are known from the prior art, for example from BP 1 940 685 B1. This insertion is carried out generally as a product is cut up into a multiplicity of slices of food, by the interleaver being cut off from an interleaver strip, preferably substantially simultaneously with the respective slices of food. The interleaver then falls together with the respective slice of food, for example onto a deposit table, on which a plurality of slices of food are configured to form a portion. Nowadays, the cutting devices are normally provided in multi-track form, i.e. a plurality of products are at least partly cut up simultaneously, so that an interleaver strip has to be provided per track.

Since the interleaver reels are finite, they have to be replaced from time to time, which was very complicated in the past.

It was therefore the object of the present invention to reduce the outlay when changing the interleaver reels.

The object is achieved with an unreeling device which has a multiplicity of cartridges, in which an interleaver reel is rotatably mounted in each case and the interleaver reel rotates as it is unreeled, the interleaver reel being braked automatically as necessary.

The explanations given in relation to this subject of the present invention apply equally to the system according to the invention and vice versa.

The present invention relates to an unreeling device for a plurality of interleaver reels. For this purpose, the unreeling device has a plurality of cartridges, in which preferably respectively one interleaver reel is rotatably mounted per cartridge. The interleaver reel rotates as the interleaver strip is unreeled. The cartridges are preferably arranged parallel to one another on the unreeling device and can be removed from the latter, preferably respectively individually. The unreeling device is preferably not a part of the cutting device but can be moved independently of the latter. The unreeling device preferably has rollers or the like, on which said device can be moved toward the cutting device and away from the latter.

Each cartridge provides the interleaver strip for one track of the cutting device, in which a product, for example a block of sausage, cheese or ham is respectively cut up. The cutting speed of the respective product in the respective track can be the same or different.

As soon as an interleaver reel has been used up, either this reel or the respective cartridge in which the used-up interleaver reel is located can be replaced, alternatively, however, the entire unreeling device can also be replaced as soon as at least one interleaver reel has been used up.

According to the invention, the respective cartridge has no brake, instead the interleaver reel is braked automatically as soon as there is no need for interleaver strip, for example when a product change is taking place in the cutting device.

The braking of the interleaver reel is preferably carried out by means of an appropriate frictional pairing between the interleaver reel, and the shaft on which the interleaver reel is mounted. Astonishingly, the interleaver reel is consequently not mounted with as little friction as possible; instead a certain friction is desired.

The interleaver reel preferably has a paperboard core, which rotates on a rigid shaft, in particular an aluminum shaft.

Preferably, the interleaver reel is driven as far as possible without momentum, i.e. is driven as slowly as possible -with the lowest possible fluctuations and without peaks, so that the unreeling speed does not exceed the transport speed of the interleaver strip or exceeds the same only slightly.

A further subject of the present invention is an unreeling device which has a multiplicity of cartridges, in which an interleaver reel is rotatably mounted, in each case, wherein each cartridge has a braking means which is activated individually.

Preferably, the torque of the brake is a function of the weight of the reel, i.e. the further the consumption of the respective interleaver reel has progressed.

In a preferred embodiment of the present invention, the unreeling device and/or the respective cartridge has no dedicated drive for the interleaver reels and/or no drive for the respective braking means. As a result, the unreeling device according to the invention can be implemented very simply and economically.

The drive for the interleaver reels and/or for the braking means of the respective cartridge is preferably provided by the cutting device. For example, the cutting device has a rotary or linear drive per cartridge, which drives the respective braking means. Preferably, the cutting device has a drive for all the interleaver reels, wherein, particularly preferably, the respective interleaver reel can be connected individually to this drive, for example by a magnetic coupling.

A further subject of the present invention is a system comprising a cutting device, in which a knife severs slices of food from a block of food, which slices are arranged, at least partly overlapping, to form a portion of a plurality of slices of food, therein an interleaver (10) is respectively provided between two slices of food, and comprising an unreeling device as claimed in one of the preceding claims.

This subject of the present invention relates to a cutting device with which blocks of food, for example blocks of cheese, sausage and/or ham, are cut up into slices of food. For this purpose, the cutting device has, for example, a rotating cutting knife, which severs the slices of food from the front end of the block of food. Here, the cutting knife interacts with what is known as a cutting edge, which functions as an opposing knife and, together with the cutting knife, defines the so-called cutting plane. Provided between the cutting knife and the cutting edge is an adjustable cutting gap, which should be as small as possible, in order to prevent the slices being “chopped off”. The cutting gap must however be sufficiently large that contact between cutting knife and cutting edge is reliably prevented. The cutting knife is arranged on a rotor. This rotor is preferably what is known as an idle cut rotor, with which the cutting knife is spaced axially apart from the front end of the block of food and the cutting plane, for example to transport a finished portion of slices of food away out of the cutting area of the cutting knife. In the spaced-apart position, the cutting knife continues to rotate with an unchanged rotational speed but does not sever any slices of food from the block of food. This movement of the cutting knife is designated an “idle cut”. As soon as the outward transport of the portion of slices of food has been completed, the cutting knife is moved back into the cutting plane again and the cutting device is continued. The cutting device has a plurality of tracks, which each have a dedicated drive that transports the product to be cut up in the direction of the cutting knife. With this forward drive, the thickness of the respective slice of food to be cut off is determined, corresponding to the forward drive of the respective product between two cuts. The forward drive can be different for each track, so that the respective products can also be cut up at different speeds.

Consequently, the consumption of the respective interleaver reel and the drive thereof can also be different.

The slices of food that are cut off are configured to form portions of a plurality of slices of food, wherein the slices of food of a portion at least partly overlap. For instances, the slices of food are stacked or shingled. An interleaver, for example a piece of paper, is arranged respectively between two slices of food and/or between portion and a support, in order to reduce the adhesion between the slices of food and/or a package.

This interleaver is preferably cut off, by the same knife which exits off the slices of food, from an interleaver strip which, for this purpose, is preferably inserted intermittently into the cutting place as soon, as the knife is no longer located in the area of the interleaver strip outlet. This insertion must then be completed at the latest when the knife enters the area of the interleaver strip outlet again. The insertion of the interleaver strip is preferably carried out individually for each track of the cutting device.

Preferably, a means which respectively drives the braking means of a cartridge is provided on the cutting device. This embodiment of the present invention has the advantage that each interleaver reel can be unreeled at an individual speed. In addition, the unreeling device does not have to have a drive for the brake of the respective cartridge, so that the latter can be designed more simply and more easily.

Preferably, the system according to the invention, in particular the cutting device, has a sensor which respectively determines the interleaver reel circumference. By using the signal from this sensor, for example, the drive of the braking means and/or the drive means for the respective interleaver reel can be controlled. In addition, by using this signal, the progress of the consumption of the respective interleaver real can be monitored and, for example, a replacement can be initiated in good time.

Preferably, the cutting device has a drive for the interleaver reels, which it rotates in order to unreel the interleaver strip. Particularly preferably, the number of drive moans is smaller than the number of interleaver reels which have to be driven. Quite particularly preferably, only one drive is provided for all the interleaver reels. Preferably, between the drive and the respective interleaver reel there is provided a coupling, which can be activated as desired and with which the respective interleaver reel can optionally be driven. As a result, the time period and/or the speed at which the respective interleaver reel is driven can be adjusted individually.

Preferably, at least two accumulators per interleaver strip are provided between the interleaver reel and the location at which the interleaver strip is inserted into the cutting plane. These accumulators preferably have different storage capacities, a buffer having a small storage capacity preferably being provided upstream of the insertion location in relation to the transport direction of the interleaver strip, and a further accumulator with a higher storage capacity preferably being provided upstream of the first buffer in relation to the transport direction of the interleaver strip. By means of the buffers, damage, in particular tearing of the interleaver strip, is prevented and/or the unreeling of the interleaver reels can be evened out, at least somewhat. At least one of the two buffers, preferably both buffers, is/are provided for each track and independently of each other.

Preferably, each buffer having the higher storage capacity has a dancer, which is preferably provided with position sensing, the signal from which is used to control the unreeling of the interleaver reel of the respective track. Preferably, rollers are provided on the dancer and the buffer additionally has farther stationary rollers. The interleaver strip is led around the rollers on the dancer and around the stationary rollers.

Preferably, the dancer has a drive, with which the position thereof can be changed independently of the interleaver strip. Therefore, the dancer can for example be moved into a threading position, which it assumes when a new interleaver strip is introduced into the system.

Preferably, the dancer has a drive, for example a belt, with which at least one roller of the buffer can be driven, in particular when the dancer is located in its threading position.

Preferably, the dancer is a multiple dancer, i.e. it has a plurality of rollers around which an interleaver strip respectively wraps. As a result, the buffer has a higher buffer capacity.

As a rule, the system, in particular the cutting device, has a guide for the interleaver strip, along which said strip is guided on its path from the interleaver reel as far as the insertion area. Preferably, this interleaver strip guide is provided so as to be partially movable, in particular pivotable, so that the length thereof can be changed. This change is made, in particular, in the area of the first buffer. As a result, the path of the interleaver strip can be lengthened or shortened. Preferably, the interleaver guide is shortened, is particular when threading the interleaver strip, and then lengthened again.

Preferably, the cutting device has docking means her the unreeling device, which ensure that the unreeling device is located in a defined position relative to the cutting device. This docking device preferably acts in two or three spatial directions which, in particular, are provided at an angle of 90° to one another. Particularly preferably, the cutting device and/or the unreeling device has/have means which fix the unreeling device as soon as the latter has assumed the defined position.

A still further subject of the present invention is a method for unreeling an interleaver reel, in particular by using the system according to the invention, wherein as the interleaver reel is unreeled, a buffer is operated such that, in the event of as emergency stop, it buffers the overrun of the reel.

The disclosure mad in relation to this subject of the present invention applies equally to the other subjects of the present invention and vice versa.

According to the invention, in the method according to the invention a buffer which is provided downstream of the interleaver reel for the interleaver strip is operated in such a way that it compensates for a difference between the unreeling speed and the consumption of the interleaver strip but at the same time has a residual buffer capacity that is sufficiently large that, in the event of a necessary stop, it buffers the overrun of the interleaver reel, which is braked only by friction.

Preferably, the unreeling of the interleaver reel is carried out at least virtually without momentum, i.e. the third derivative of the distance/time graph of the interleaver strip is zero or virtually zero.

A further subject of the present invention is a cutting device, with which a product is cut up into a multiplicity of slices of food, in which the product is transported in the direction of a moving, preferably rotating, knife, which severs the slices of food from the front end of the product, which slices fall onto a supporting surface and are configured there to form portions of a plurality of slices of food, characterised in that at least one, preferably moving, part of the cutting device at least partly made of a material with a high strength and preferably a comparatively low density, in particular of ceramic, is provided.

The disclosure made in relation to this subject of the present invention applies equally to the other subjects of the present invention and vice versa.

The present invention relates to a device for cutting up products, in which at least one part made of a material with a high strength and preferably a comparatively low density, at least partly, is provided. Preferably, this is a moving, for example rotating, component which, quite particularly preferably, is driven intermittently. Further preferably, the part is provided so as to be very stiff and is particularly preferably subjected to very high accelerations.

Preferably, the part is at least partly made of ceramic. In particular, this is a ceramic with a comparatively low density, for example SiC or SiSiC or Al₂O₃.

Preferably, the part, in particular the part made of ceramic, is prestressed, in particular prestressed in compression.

Furthermore, the ceramic part is preferably connected to another part by an integral connection, in particular by adhesive bonding.

Preferably, the ceramic part is provided on the outer circumference of a rotating component.

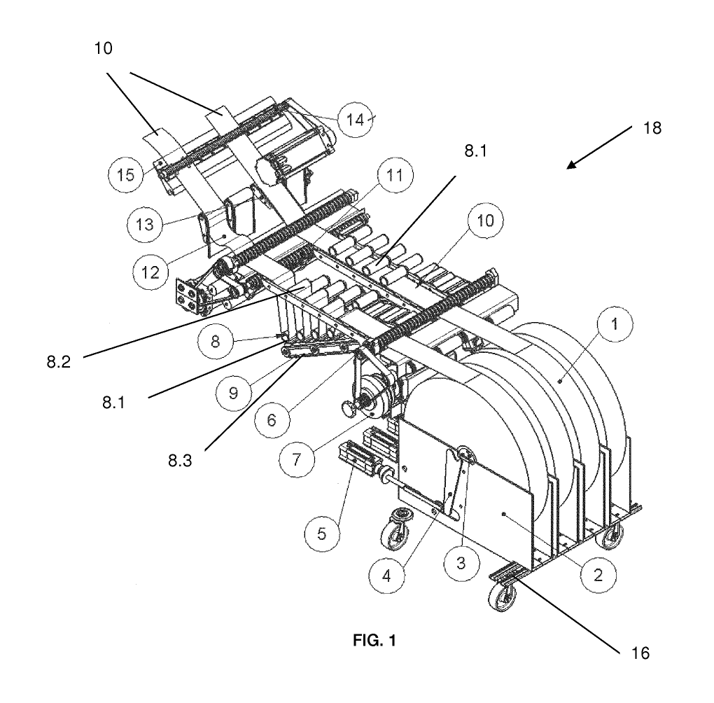

The inventions will be explained below by using FIGS. 1 to 4. These explanations are merely exemplary and do not restrict the general idea of the invention.

FIG. 1 shows the system according to the invention.

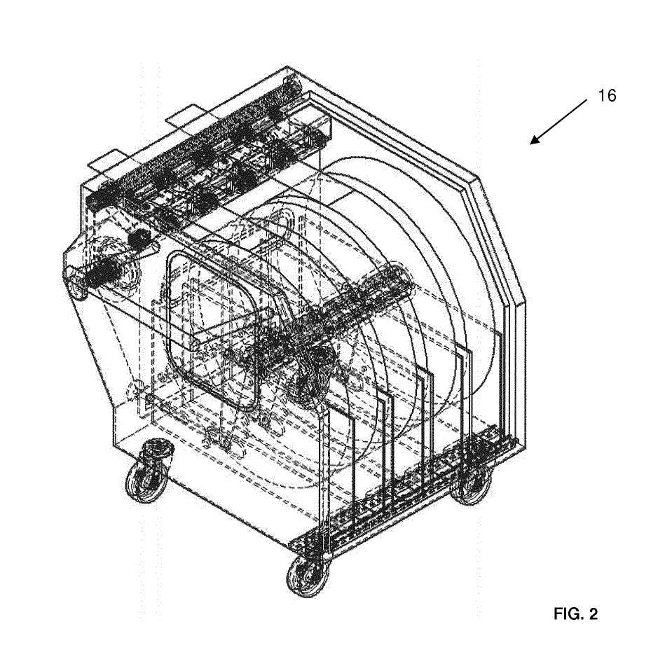

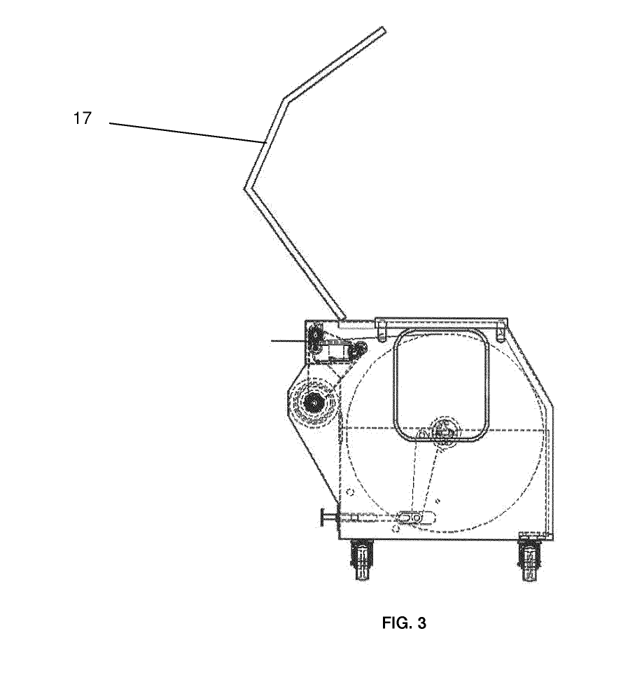

FIGS. 2 and 3 each show illustrations of the unreeling device according to the invention.

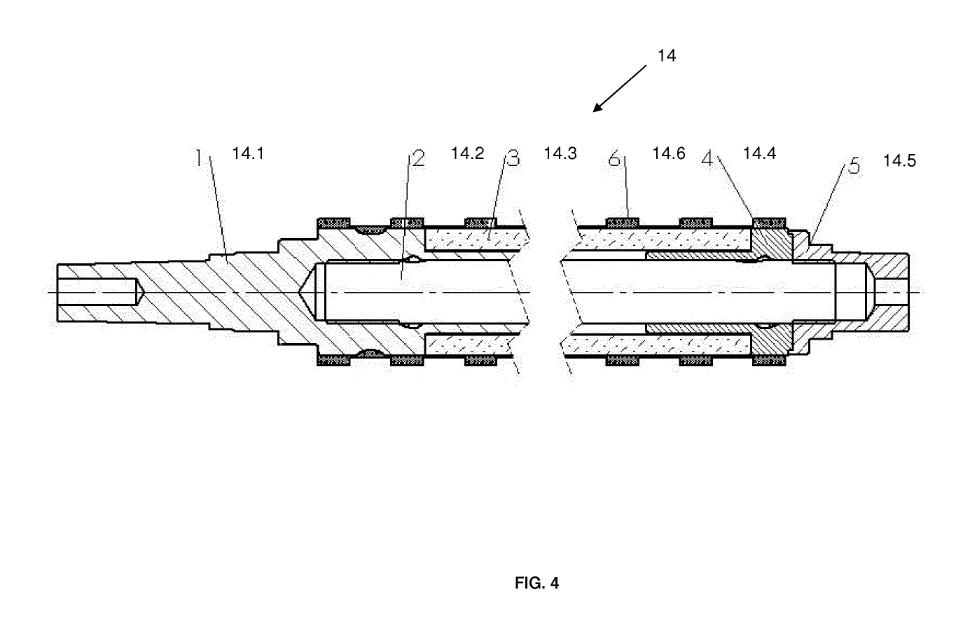

FIG. 4 shows the drive shaft for the interleaver strip.

FIG. 1 shows, schematically, the system according to the invention. This comprises a cutting device and the unreeling device 16. The cutting device in the present case has four tracks, into which it is respectively possible to insert a product which is transported in the direction of a cutting knife, for example a rotating cutting knife, which severs slices of food from the front end of the product. The feed rate of the products per track can thus be different. The slices cut off fall, for example, onto a deposit table and are configured there to form portions of a plurality of slices. For example, the portions are arranged as stacks or as shingled portions. According to the invention, provision is now made for a so-called “interleaver” to be placed between two slices in each case. The interleaver is, for example, paper, in particular coated paper or a film, which reduces the adhesive forces between two slices of food. As a result, it becomes simpler for the user to separate a slice of food from the portion. The interleaver is provided as interleaver strip 10, which are preferably inserted intermittently into the cutting plane of the knife which severs the respective interleaver from the interleaver strip. The interleaver that is cut off falls onto the deposit table together with the slice that is being cut off. An interleaver strip is provided for each track. Each interleaver strip 10 of the respective track is unreeled from an interleaver reel, here a paper reel, which is respectively provided in a cartridge 2. The cartridges 2 are arranged beside one another on the unreeling device 16. In the present case, the unreeling device 16 has rollers, with which it can be rolled to the cutting device. Each cassette 2, which is provided in the shape of a U in the present case, has a rotary bearing for the interleaver reel and a braking means 3, for example a brake blade 3, which brakes the respective interleaver reel as desired. Preferably, the braking torque here depends on the progress of the consumption of the respective interleaver reel. For example, the cutting device has a sensor which monitors the progress of the consumption of each interleaver reel 1. Preferably, the unreeling device 16 has no dedicated drive for the interleaver reels and/or no dedicated drive for the respective braking means. As a result, the unreeling device can be provided very simply and economically. Those skilled in the art will understand that, preferably, each interleaver reel has its own braking means, so that said reels can be braked individually and independently of the other reels. The drive 6, 7 of the interleaver reels and/or the drive 5 of the brakes is preferably provided on the cutting device. The fact that the unreeling device according to the invention preferably has no dedicated drive means that said device can be implemented very simply and has a low weight, which is advantageous for the onward movement of the unreeling device by a worker. The drive 5 of the brake of the respective film reel in the present case is a brake cylinder, which drives a lever 4 which in turn interacts with the brake blade and brakes the respective film reel. The interleaver reels in the present case have a common drive 6, wherein the torque provided by the drive is transmitted to the respective interleaver reel as desired by means of a magnetic coupling. Thus, each reel can be driven individually, in order, for example, to control the buffered interleaver strip length per track individually and/or to be suitable for the different cutting speed per track. As can be seen in particular by using the left-hand interleaver strip, after the interleaver strip has been unreeled from the reel, it runs through a buffer 8, in which interleaver strip material is buffered. In the present case, this buffer 8 is by way of stationary rollers 8.2 and movable rollers 8.1 which, in the present case, are provided rotatably on a dancer 8.3. The dancer 8.3 is provided on the cutting device, rotatably here, and preferably has a sensor with which one position thereof can be established, so that the signal from this sensor can be used to control the drive 6, 7 of the respective interleaver reel. The dancer preferably has a drive 9, for example a belt, in particular a tangential belt, which, driven by a drive 11, can run around the dancer. This drive 11 can set the stationary rollers 8.1 rotating, which is advantageous in particular when threading a new inter leaver strip, which in the illustration according to FIG. 1 is currently taking place in the right-hand interleaver strip 10. The drive for the tangential belt is the drive means 11, a roller here, which is able to interact with the drive of the dancer when the latter is in its non-buffering position, the horizontal position here, and the interleaver strip moves through the buffer 8 without any turns. Provided downstream of the first buffer 8 is a further buffer 12, a loop here, which preferably has a substantially lower capacity than the buffer 8 and preferably buffers only as much interleaver material as is needed for the ejection of an interleaver. The length of the loop is preferably monitored, in particular by a contacting sensor. This buffer 12 preferably has an interleaver strip guide 13, which is provided so as to be movable and which is able to enlarge or reduce the path of the interleaver strip. In the present case, this guide is a plane, which is provided such that it can rotate on the cutting device and which can be moved from a buffering position (left-hand interleaver strip) in to a non-buffering position (right-hand interleaver strip). Also provided downstream in relation to the direction of movement of the interleaver strip, preferably immediately adjacent to the cutting plane, is an interleaver ejection roller 14 on an interleaver ejection unit 15. Preferably, the roller is a roller having a very low weight, for example a ceramic or steel roller, which has a very low mass moment of inertia with a high stiffness. As a result, it is possible to insert the interleaver strip into the cutting plane with a very high acceleration.

According to another subject of the present invention, not shown, the reel of each cartridge has no braking means, instead is mounted in the cartridge such that there is deliberately so much friction that, in the event of a consumption stop or a reduction in consumption of the interleaver strip, the reel overruns only so slightly that the excess can be shored in the buffer 8. The buffered interleaver strip can then be used to accelerate the interleaver reel as far as possible without momentum in the event of an increase in demand. For example, each cassette has a rigid shaft made of metal, preferably of aluminum, on which the core, in particular a core of paperboard, rotates. This frictional pairing is sufficient to be able to operate the cartridge without any brake.

FIG. 2 shows the unreeling device according to the invention which, in the present case, has four cartridges, in each of which an interleaver reel 1 is rotatably mounted. Each cartridge has its own braking means, but which has no drive. Each cassette can be provided on the unreeling device such that it can be mounted/dismounted individually. The cartridges can be loaded with an interleaver reel and then mounted on the unreeling device. Preferably, the distance between the cartridges is adjustable. Preferably, the unreeling device has a sensor which monitors the progress of the consumption of the individual interleaver reel and in particular is connected to the open-loop/closed-loop control system of the system according to the invention, which outputs an appropriate signal as necessary when one or more cartridges have to be replaced or refilled. The unreeling device according to the invention preferably has no type of power supply. Preferably, means are provided in the unreeling device in order to connect the unreeling device to the cutting device and/or to achieve an exact alignment of the unreeling device relative to the cutting device, so that a reliable drive of the interleaver reels, a secure connection, to the braking means and/or twist-free unreeling of the interleaver material are possible. Preferably, the cutting device has a sensor which establishes that the unreeling device is decked correctly on the cutting device.

As can be gathered in particular from FIG. 3, the unreeling device 16 according to the invention can be covered by a folding cover 17. As a result, the device according to the invention satisfies the hygienic requirements in an operation processing foodstuffs.

FIG. 4 shows an example of part of a cutting device which is at least partly produced from a high-strength material. In the present case, this is the interleaver strip ejector roller, which inserts the interleaver strip or strips between two slices of food. This is carried out intermittently and the respective interleaver strip must be inserted very quickly, so that the interleaves strip ejector roller is intermittently subjected to very high acceleration. The interleaver strip ejector roller in the present case has a rotary bearing, here a shaft journal 14.1, which is preferably made of metal, in particular of steel. The rotary bearing preferably has a seat for a ceramic sleeve 14.3, wherein the ceramic sleeve is particularly preferably connected integrally to the seat, in particular by adhesive bonding. Provided within the ceramic sleeve in the present case is a tie rod 14.2, with which the ceramic sleeve can be prestressed in compression, so that the stiffness thereof, in particular against deflection, is increased. The tie rod interacts firstly with the bearing 14.1 and secondly with a pro-stressing nut 14.5, which at the same time acts as a bearing which is located opposite the bearing 14.1. Provided between the pre-stressing nut 14.5 and the ceramic sleeve 14.3 here is an adapter 14.4, which is preferably likewise connected integrally to the sleeve. The adapter 14.4 is preferably made of lightweight metal or plastic. Preferably provided on the circumference of the ceramic sleeve 14.3, of the hearing 14.1 and/or of the adapter, in particular at least, in some sections, is a functional surface, for example a coating, e.g. a rubber coating or a plastic, preferably provided with a structured surface which, here, interacts frictionally with the interleaver strip.

The interleaver elector roller 14 described is used here for the interleaver strip ejection and is subjected, to extremely high accelerations with a slim design. Here, the interleaver ejector roller is about 600 mm long and only 40 mm in diameter. It must exhibit extremely high bending stiffness, since if is necessary to press on the paper over the entire width with a mating shaft.

Further uses of a part which is at least partly provided from ceramic are slim shafts for the portioning bands, wherein the transitions from hand to band must be kept as small as possible and therefore the shaft diameters are chosen to be the smallest possible. Nevertheless, shafts up to 600 mm long or mere are also needed here. Here, too, high acceleration is needed for the fast transport away of the portions.

A further application is the deflection rollers of the traction belts, i.e. the belts which guide the product toward the knife.

### LIST OF DESIGNATIONS

1 Interleaver reel, paper reels

2 Cartridge

3 Braking means, brake blade

4 Lever

5 Drive for the brakeing means

6 Drive of the interleaver strip 10

7 Coupling

8 Buffer

8.1 Movable roller

8.2 Stationary roller

8.3 Dancer

9 Drive, belt, tangential belt

10 Interleaver strip

11 Drive means, roller

12 Buffer, loop

13 Interleaver strip guide

14 Interleaver ejector roller

14.1 Bearing, shaft journal

14.2 Pulling means, tie rod

14.3 Supporting body

14.4 Adapter

14.5 Prestressing nut

14.6 Functional surface

15 Interleaver ejector unit

16 Unreeling device

17 Cover

18 System

What is claimed is:

1. An unreeling device comprising:
a multiplicity of cartridges; and
an interleaver reel rotatably mounted in each cartridge,
wherein the interleaver reel in each cartridge rotates as an interleaver is unreeled therefrom, and
wherein the interleaver reels are braked automatically as necessary.

2. The unreeling device as claimed in claim 1, wherein the interleaver reel in each cartridge has a core that rotates on a rigid shaft,
wherein the core is a paper core and the shaft is an aluminum shaft.

3. The unreeling device as claimed in claim 1, wherein each of the cartridges has a braking means that is activated individually.

4. The unreeling device as claimed in claim 3, wherein a torque of the braking means is a function of a weight of the interleaver reel in a corresponding cartridge.

5. The unreeling device as claimed in claim 1, wherein the unreeling device is free of a drive for the interleaver reels.

6. A system comprising;
i. a cutting device including a knife that severs slices of food from a block of food, the slices are arranged so that the slices at least partly overlap to form a portion of a plurality of the slices of food,
wherein an interleaver is provided between two of the slices of food, and
ii. an unreeling device comprising:
one or more cartridges;
an interleaver reel rotatably mounted in each of the one the interleaver reel includes an interleaver,
wherein the interleaver reel is automatically braked with a braking means when there is no need for the interleaver.

7. The system as claimed in claim 6, wherein the system includes a means that drives the braking means, which is provided on the cutting device.

8. The system as claimed in claim 6, wherein the system has a sensor that determines a circumference of the interleaver reel.

9. The system as claimed in claim 6, wherein the cutting device has a drive for the interleaver reel.

10. The system as claimed in claim 6, wherein the system has at least two buffers per interleaver reel.

11. The system as claimed in claim 10, wherein at least one of the buffers has a dancer.

12. The system as claimed in claim 6, wherein the system includes an interleaver strip guide that is partly movable, pivotable, or both.

13. A method comprising:
unreeling an interleaver from an interleaver reel that is supported on an unreeling device,
wherein the unreeling device comprises a cartridge rotatably supporting the interleaver reel;
wherein the interleaver reel is braked automatically when there is no need for the interleaver, and
wherein as the interleaver reel is unreeled, a buffer is operated such that, in the event of an emergency stop, the buffer buffers an overrun of the interleaver reel.

14. The method as claimed in claim 13, wherein the unreeling step is carried out at least virtually without momentum.

15. A cutting device, with which a product is cut up into a multiplicity of slices of food, in which the product is transported in a direction of a moving, rotating knife, which severs the slices of food from a front end of the product,
wherein the slices fall onto a supporting surface and are configured there to form portions of a plurality of the slices of food, and
wherein at least one moving part of the cutting device is at least partly made of a material with a high strength and low density ceramic.

16. The unreeling device as claimed in claim 1, wherein the unreeling device includes at least one buffer,
wherein after the interleaver is unreeled from the interleaver ree;, the interleaver runs through the at least one buffer to buffer the interleaver.

17. The unreeling device as claimed in claim 16, wherein when threading a new interleaver, the at least one buffer is moved so that the new interleaver is not buffered.

18. The unreeling device as claimed in claim 1, wherein friction between the interleaver reel and a corresponding cartridge causes the interleaver reel to brake automatically when there is an interleaver consumption stop, or a reduction consumption of the interleaver.

19. The system as claimed in claim 11 wherein the dancer includes one or more stationary rollers and one or more movable rollers,
wherein after the interleaver is unreeled from a corresponding interleaver roller, the moveable rollers are moved so that the interleaver is buffered, and
wherein when threading a new interleaver, the moveable rollers are moved so that the new interleaver is not buffered.

20. The method as claimed in claim 13, wherein the method includes a step of moving one or more rollers when threading a new interleaver so that the new interleaver is not buffered.
